(19) United States
(12) Patent Application Publication
(10) Pub. No.: US 2005/0049947 A1
(43) Pub. Date: Mar. 3, 2005

(54) Electronic processing of bills using an ID of an automatically generated advice of settlement

(76) Inventors: Thomas Mueller, Wiesloch (DE); Jurgen Kohling, Hockenheim (DE)

Correspondence Address: FINNEGAN, HENDERSON, FARABOW, GARRETT & DUNNER;LLP, 1300 I STREET, NW, WASHINGTON, DC, 20005, US

(21) Appl. No.: 10/893,873

(22) Filed: Jul. 20, 2004

(30) Foreign Application Priority Data
Jul. 21, 2003 (EP) 03015693.9

(51) Int. Cl. G06F 17/60

(52) U.S. Cl. 705/34

(57) ABSTRACT

Methods and systems are provided for processing one or more bills from a biller by a customer. Methods and systems may receive a request to pay one or more of a set of one or more bills in total or in part on a site of a computer network. A selection of the one or more bills to a biller may be sent, said selection responding to said request via said site. Methods and systems may receive an electronic advice of settlement of the selected bills and/or an ID of said advice of settlement from the biller and send a payment order comprising the ID of said advice of settlement to a payment service provider.

### TECHNICAL FIELD

The present invention generally relates to electronic data processing. More particularly, the invention relates to methods, computer program products and systems for automated bill presentment and, in one example, internet based bill presentment and payment.

### BACKGROUND

If a customer pays two or more bills from a biller by way of a self-initiated payment method using a payment order, which can be implemented by a paper-based payment carrier (e.g., cheque), a bank transfer, or electronically via bank transfer by online—or internet banking in one amount, the biller has the problem of identifying which partial amount of the total incoming payment amount belongs to which bill. In such cases, particularly if a plurality of bills are paid with a single payment, it is common practice for customers to send a so called advice of settlement to the biller parallel to the payment. The advice of settlement comprises a detailed list of the bills to be paid including the respective (partial-) amounts. Such advice of settlement can have a volume of a few hundred pages in cases of business relationships, in which a large company is on the customer side. The advice of settlement is sent as a hard copy to the biller and the customer references to the particular advice of settlement on the payment order.

This procedure has several disadvantages: The customer has to create the advice of settlement, either electronically (by means of his business software) or by hand; he has to send it to the biller (either by normal mail or by email), thereby addressing it to the correct address and the responsible person, which is often very difficult; and he has to ensure that the advice of settlement reaches the biller at about the same time as the payment. The biller on the other side has to process the incoming advice of settlement. This means that he has to enter the data into his business software system. In order to allow an automatic processing of the incoming payment, the data must be entered before the payment is made. In case the customer does not send any advice of settlement—or it arrives far too late—the biller has the problem to assign the correct bills to the amount or partial amounts. This causes complex queries to the customer.

Another issue is that modern business software payments, which cannot be exactly assigned to specific bills, are often automatically distributed to open items. This often causes erroneous bookings with subsequent cancellation bookings, which waste storage of the computer system and strain performance.

Thus, there is a need for a method, software application and/or data processing system providing a more efficient solution of at least some of the problems described above. Particularly, it may be desirable to provide a software application having a mechanism for enabling a better processing of bills or payments in combination with an advice of settlement.

The above description is based on the knowledge of the present inventors and not necessarily that known in the art.

### SUMMARY

Methods and systems consistent with principles of the present invention may process one or more bills from a biller by a customer.

Methods and systems may receive a request to pay one or more of a set of one or more bills in total or in part on a site of a computer network.

Methods and systems may send a selection of the one or more bills to a biller, said selection responding to said request via said site. An electronic advice of settlement of the selected bills and/or an ID of said advice of settlement may be received from the biller.

Methods and systems may send a payment order comprising the ID of said advice of settlement to a payment service provider.

One aspect consistent with the present invention may include providing a computer system for processing one or more bills from a biller by a customer.

The system may comprise a memory having program instructions; input means for receiving and entering data; output means for sending and presenting data; storage means for storing data; and a processor responsive to the program instructions.

Consistent with the present invention, the instructions may cause the processor to receive a request to pay one or more of a set of one or more bills in total or in part on a site of a computer network; send a selection of the one or more bills to a biller, said selection responding to said request via said site; receive an electronic advice of settlement of the selected bills and/or an ID of said advice of settlement from the biller; and send a payment order comprising the ID of said advice of settlement to a payment service provider.

Applying the method, e.g. by using the system, is insofar advantageous as on the biller side a lot of work regarding the assignment of incoming payments to the underlying bills is avoided and—at the same time—the biller's computer system computer system can run more efficiently, due to a lesser waste of storage space and a better process time. On the customer side, the generation of advice of settlement is no longer necessary, thus saving work load and time of the customer and its computer system as well.

Embodiments consistent with the invention are further directed to a computer system, a computer program, a computer readable medium and a carrier signal, each comprising program code or instructions for processing one or more bills from a biller by a customer according to the above method and its embodiments. Such instructions cause a computer system to perform methods of the present invention, if the instructions are carried out on a computer system.

Such a computer program can be installed as one or more programs or program modules on different hardware systems (computers or computer systems), and run separately and independently of each other. The different systems may be connected in the form of a network to communicate with each other.

The various embodiments can include and/or exclude different aspects, features and/or advantages, where applicable. In addition, various embodiments can combine one or more aspects or features of other embodiments, where applicable.

It is understood that both, the foregoing general description and the following detailed description, are exemplary and explanatory only and are not restrictive of the embodiments of the invention, as claimed. The description of aspects, features and/or advantages of particular embodiments should not be construed as limiting other embodiments or the claims.

### BRIEF DESCRIPTION OF THE DRAWINGS

The accompanying drawings, which are incorporated in and constitute a part of this specification, illustrate embodiments consistent with the invention and, together with the description, explain the principles of the invention. In the drawings,

FIG. 1a is a schematic block diagram of an implementation of a system for presenting bills via a site in a network by means of a computer system;

FIG. 1b is an exemplary block diagram of an implementation of a method consistent with the present invention by means of a computer system connectable to the computer system of FIG. 1a; and

FIG. 2 is flow diagram of a method consistent with principles of the present invention.

### DETAILED DESCRIPTION

Computer systems and program are closely related. As used herein, phrases, such as “the computer provides”, “the program provides or performs specific actions”, and “a user performs a specific action” refer to actions by a computer system that may be controlled by a program. These phrases may also express that the program or program module is designed to enable the computer system to perform the specific action or to enable a user to perform the specific action by means of a computer system.

It should be understood that the term “presentment” as used herein does not only include the specialized definition normally associated with commercial paper, i.e. the production on a negotiable instrument to a drawee. Rather, the term refers to providing information via electronic means as well. This electronic presentment may, for example, take place through the use of an internet—or intranet website or via email or SMS, e.g. by making a web site accessible to one or more persons.

The terms used herein shall have their usual meaning in the context of the field of data processing unless defined otherwise. Particularly, a computer system can be a stand alone computer such as a PC, a laptop, a series of computers connected as a network, e.g. a network within a company, or a series of computers connected via the internet.

Methods consistent with the present invention may be implemented by a computer system connected to the internet, thus forming part of a network. Said computer system may comprise one or more program modules for performing method steps. The presentment of the list of bills by the biller can be implemented by an internet web site. This web site can be accessed by a customer, e.g. after an authentication step. The internet web site can be implemented as is known in the art, in the form of a XML- or HTML file, in which the relevant bill data are included. A link to that file, preferably a hyperlink, can be generated and presented to the customer. The customer, connected to an intranet or to the internet can apply the link, open the web site by means of a web browser, which can be integrated in the business software of the customer for data import and which can present the content of the file on the display. The customer can then select one or more bills, e.g. by checking of check boxes presented to him by the web browser. When applying a “send” function or button presented by the web browser, the web browser sends the data (i.e., information regarding which bills are selected) back to the computer system of the biller, who receives a selection of the one-or more bills. The computer system of the biller then automatically generates an electronic advice of settlement, in which data of the selected bills are included. Typically, bill number, amount, bill subject, bill date and the like can be used. These data can be taken from a business database of the biller. Further, an identifier (ID) is created and assigned to the electronic advice of settlement. This ID can be marked as such, in order to allow its automatic import into the business or payment software of the customer. Such electronic advice of settlement can be implemented e.g. as an XML—HTML file as well. Similarly, a link or hyperlink to that electronic advice of settlement can be created and presented to the customer. The ID can be incorporated into the advice of settlement and/or into a web page and/or into a subsequent web page.

The customer thus can download the electronic advice of settlement or the ID, automatically import the ID into his business software and/or payment system, and transfer a payment order comprising the ID to a payment service provider. The customer's computer system then transfers customer data (address, account no., etc.), payment data (currency, amount, etc.) biller data (bank, account no., etc.) and the ID to a preselectable payment service provider. Alternatively, the ID can be included in a separate file. However, the further process of down loading and accessing is analogous.

In order to present the ID to a payment service provider, the ID can be incorporated, for example, into the use section of a payment order, e.g. manually on a paper form, or electronically on an online—or internet banking form. The incorporation into the electronic form can be performed manually or automatically by a software application.

Consistent with embodiments of the present invention, editable data fields may be provided (e.g., included in a site of a computer network). This can be implemented by a web page, which provides editable data fields to a user. The editable data fields can be coupled with tables from which predefinable values for the respective data field can be selected and entered into the respective data field. The user, e.g. a customer, can enter comments into the fields, specify a partial amount he wants to pay, and/or correct erroneous data of the bills presented. This step is particularly useful, e.g., when a customer decides to pay only a partial amount of a selected bill. The computer system of the biller then uses the amount sent to it by the customer system and includes it into the electronic advice of settlement.

Consistent with embodiments of the present invention, the site may comprise a list of one or more payment service providers for selection by the customer. After having selected the bills, the customer can chose from a table a payment service provider, e.g. a bank of which he is a customer, he wants to use for the payment of the selected bills. The computer system of the biller then creates from the selected bills a set of payment data, the advice of settlement and its ID and sends the payment data together with the ID and biller and—if so adjusted—the customer data to the customer. The customer can then—if not already included—add his customer data and forward the payment data including the ID to the selected payment service provider. The payment service provider processes the payment to the bank of the biller, from which the payment information including the ID is sent to the business software system of the biller, which then can automatically assign the paid amount to the respective bills by the ID and the associated advice of settlement generated before.

Consistent with embodiments of the present invention, a confirmation of payment, referenced by an ID of an electronic advice of settlement, may be received.

Processors suitable for the execution of a computer program include, by way of example, both general and special purpose microprocessors, and any one or more processors of any kind of a digital computer. Generally, a processor will receive instructions and data from a read-only memory and/or a random access memory. A computer may include a processor for executing instructions and one or more memory devices for storing instructions and data. Generally, a computer will also include, and/or be operatively coupled to receive data from and/or transfer data to, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer system having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or haptic feedback; and input from the user can be received in any form, including acoustic, speech, or haptic input.

Reference will now be made in detail to the principles and embodiments, consistent with the invention, by an explanation on the basis of a data processing process, examples of which are illustrated in the accompanying drawings. Examples mentioned therein are for explanatory purpose only and shall not limit the invention in any way.

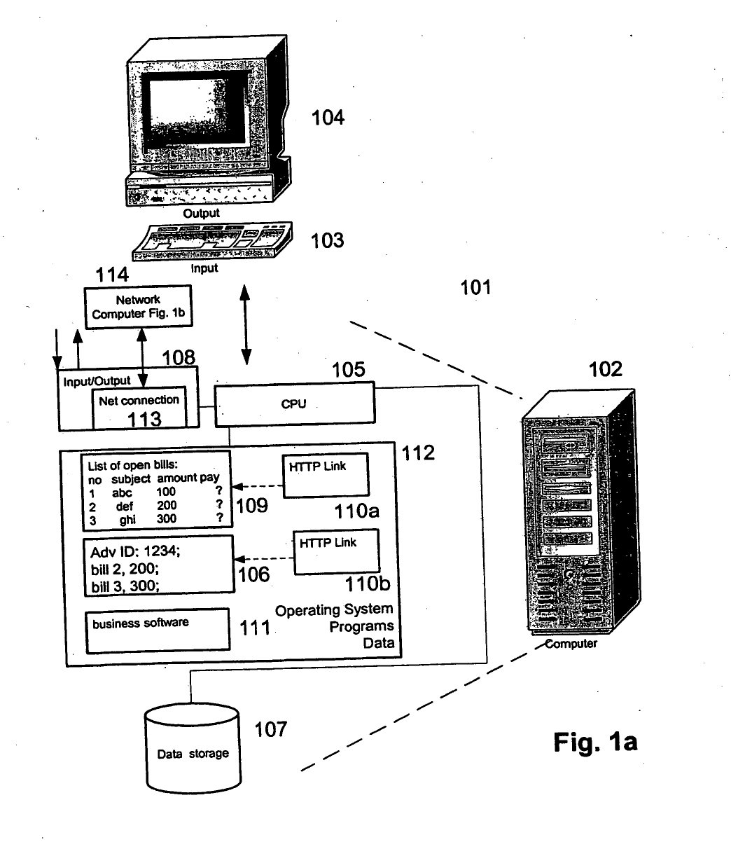

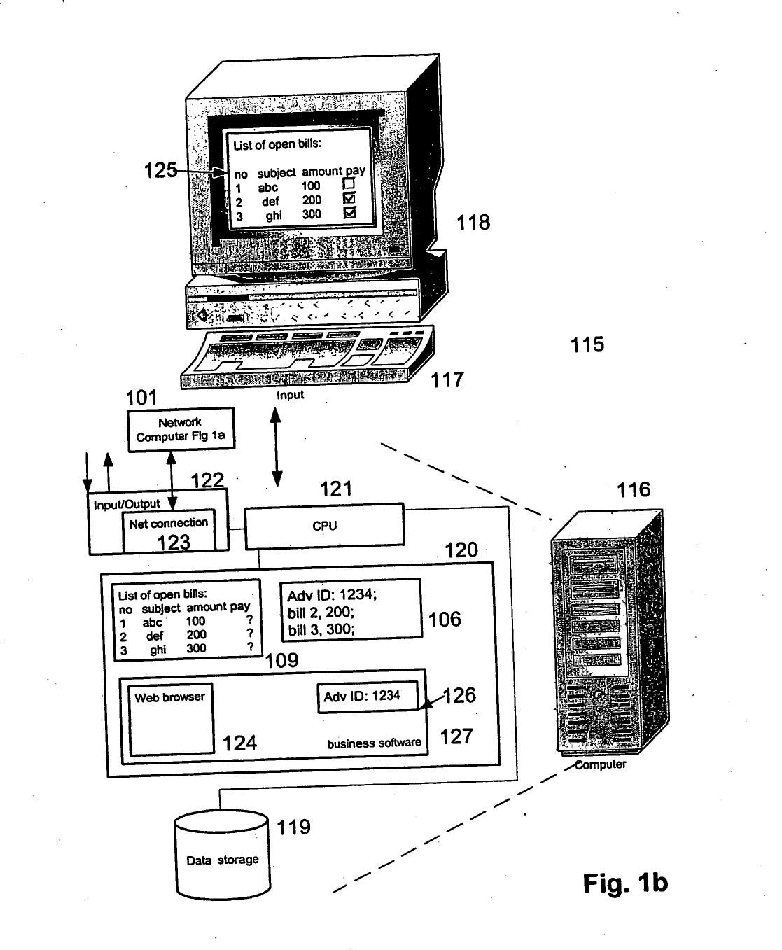

FIG. 1a shows one example of an implementation of a method for presenting one or more bills to a customer via a site of a network: a computer system 101 comprising a computer 102 having a CPU 105, a working storage 112 (memory), in which an operating system, data and software applications are stored for processing by CPU 105. The software applications comprise a business software application 111 for creating and presenting bills electronically. Software application 111 can comprise one or more program modules for performing specific tasks.

Computer System 101 further comprises input means 103; output means 104 for interaction with a user, e.g. for starting the program modules and/or for data input; and general input/output means 108, including a net connection 113, for sending and receiving data (e.g., data on billing information, bills, payment orders, customer and biller master data, etc.) via an intranet or the internet. A plurality of computer systems 101 can be connected via the net connection 113 in the form of a network. In such a case, each of the modules of the business software 111 can be installed and run separately and independently on the respective network computers. In this case, the network computers 114 can be used as further input/output means, including the use as further storage locations. Net connection 113 further allows a connection with a computer system 114 of a customer. Computer system 101 further comprises a first storage means 107, in which business and billing data of the customer(s) are stored.

FIG. 1b illustrates a customer-based computer system 115 for interaction with the computer system 101 of a biller, the computer system having program modules for performing the described method and its embodiments described in this specification. Similarly to FIG. 1b, computer system 115 comprises computer 116, CPU 121, memory 120, input 117 and output 118 for interaction with a user, mass storage 119, general input/output 122 for data exchange, including net connection 123. A plurality of computer systems 115 can be connected via the net connection 123 in the form of a network, and each of the modules of the business software 127 can be installed and run separately and independently on the respective network computers. In this case, the network computers 101 can be used as further input/output means, including the use as further storage locations.

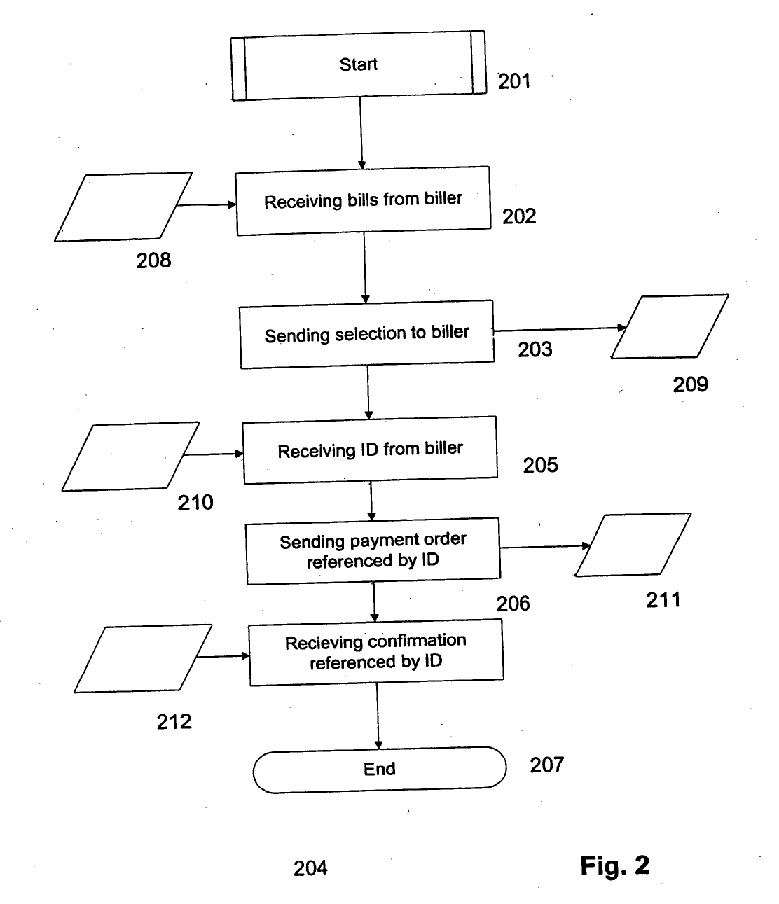

FIG. 2 is a flow diagram of an exemplary process consistent with embodiments of the present invention.

Previous to the start step 201, a structured document 109 (FIG. 1a) containing a list of open bills and relevant billing data like bill no, subject, amount, date etc. is created by business application 111 of the biller. The structured document 109 can be for example a XML- or HTML file. It further comprises information to enable a web browser to display the bill data and selecting means on a screen. Further, a HTTP link 110a, pointing to the document 109 is created. In order to present the list of open bills to a customer, the link 110a, is sent to the customer. The customer receives and applies the link by means of computer system 115 and web browser 124 (FIG. 1b). Web browser 124 accesses via the net connection 123 the document 109 and displays its content, particularly a list of bills 208, as a web page 125 on the output 118, the customer thereby receiving bills comprising bill data 208 (step 202). The customer can select one or more bills by checking the presented check boxes in the “pay” column of the page 125. In this example, the customer intends to pay bills nos. 2 and 3. After applying a “send” function (not shown), the browser 124 sends the modified document 209 comprising modified bill data (selected bills) back to the computer system 101 (step 203). System 101 receives the selection 209 from the customer and creates a advice of settlement 106 and an ID there from. The advice of settlement can have the form of an XML- or HTML file as well. It contains an ID, “1234” in the example, and billing data of the selected bills. The ID is incorporated into the document 109, and e.g. upon the refresh function of the web browser 124 is displayed on the output 118. Another possibility is to incorporate the ID into a subsequent web page 210 and thus present it to the customer. The customer can then transfer the ID presented to him automatically into an electronic payment order or manually into payment orders. Alternatively, the ID can be stored in a separate structured document. Further, a link 110b can be created, which points to the advice of settlement 106 or the document of the ID. In order to present the advice of settlement and/or the ID to the customer, the link 10b is sent to the customer. By applying the link via web browser 124, the web browser accesses the corresponding file 210 and display the ID on the monitor. The ID can then automatically or manually be entered into a payment order 211 as a reference to the advice of settlement. Payment order 211 can be implemented by a paper based payment carrier or an electronic payment form. The payment order 211 can automatically be sent to a preselectable payment service provider (step 206), e.g., by automatic mail system or via internet. The payment service provider processes the payment, and the customer subsequently receives (step 207) a confirmation 212 of payment via his banking institute or via the customer, whereby the confirmation 212 contains the ID, which references to the advice of settlement generated before.

Modifications and adaptations of the present invention will be apparent to those skilled in the art from consideration of the specification and practice of the invention disclosed herein. The foregoing description has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

1. A method for processing one or more bills from a biller by a customer, comprising:
receiving a request to pay one or more of a set of one or more bills in total or in part on a site of a computer network;
sending a selection of the one or more bills to a biller, said selection responding to said request via said site;
receiving an electronic advice of settlement of the selected bills and an ID of said advice of settlement from the biller; and
sending a payment order comprising the ID of said advice of settlement to a payment service provider.

2. The method of claim 1, further comprising:
providing editable data fields via the site.

3. The method of claim 1, further comprising:
providing a list of one or more payment service providers for selection by the customer.

4. The method of claim 2, further comprising:
providing a list of one or more payment service providers for selection by the customer.

5. The method via the site of claim 1, 2, 3, or 4, further comprising:
receiving a confirmation of payment, referenced by an ID of an electronic advice of settlement.

6. A computer system for processing one or more bills from a biller by a customer, comprising:
a memory having program instructions;
input means for receiving and entering data;
output means for sending and presenting data;
storage means for storing data; and
a processor responsive to the program instructions to:
receive a request to pay one or more of a set of one or more bills in total or in part on a site of a computer network,
send a selection of the one or more bills to a biller, said selection responding to said request via said site,
receive an electronic advice of settlement of the selected bills and/or an ID of said advice of settlement from the biller, and
send a payment order comprising the ID of said advice of settlement to a payment service provider.

7. The computer system of claim 6, wherein
said site includes editable data fields.

8. The computer system of claim 6 or 7, wherein
said site comprises a list of one or more payment service providers for selection by the customer.

9. The computer system of claim 6, 7, or 8, wherein the processor is responsive to instructions to receive a confirmation of payment, referenced by an ID of an electronic advice of settlement.

10. A computer readable medium comprising executable instructions for performing a method of processing one or more bills from a biller by a customer, the method comprising:
receiving a request to pay one or more of a set of one or more bills in total or in part on a site of a computer network;
sending a selection of the one or more bills to a biller, said selection responding to said request via said site;
receiving an electronic advice of settlement of the selected bills and/or an ID of said advice of settlement from the biller; and
sending a payment order comprising the ID of said advice of settlement to a payment service provider.

11. The computer readable medium of claim 10, wherein the instructions include instructions for providing editable data fields in the site.

12. The computer readable medium of claim 10 or 11, wherein said site comprises a list of at least one payment service provider for selection by the customer.

13. The computer readable medium of one or more of claims 10 or 11, further comprising instructions for:
receiving a confirmation of payment, referenced by an ID of an electronic advice of settlement.

14. A computer data signal embodied in a carrier wave comprising:
code for processing one or more bills from a biller by a customer, said code including executable instructions for
receiving a request to pay one or more of a set of one or more bills in total or in part on a site of a computer network;
sending a selection of the one or more bills to a biller, said selection responding to said request via said site;
receiving an electronic advice of settlement of the selected bills and/or an ID of said advice of settlement from the biller; and
sending a payment order comprising the ID of said advice of settlement to a payment service provider.
